(19) United States
(12) Patent Application Publication
(10) Pub. No.: US 2022/0414291 A1
(43) Pub. Date: Dec. 29, 2022

(54) Device for Defining a Sequence of Movements in a Generic Model

(71) Applicant: CAPSIX, Saint-Cyr-Au-Mont-D'Or (FR)

(72) Inventors: François Eyssautier, Saint-Cyr-Au-Mont-D'or (FR); Guillaume Gibert, Lyon (FR)

(21) Appl. No.: 17/770,254

(22) PCT Filed: Nov. 30, 2020
(86) PCT No.: PCT/FR2020/052217

§ 371 Date: Sep. 15, 2022

(30) Foreign Application Priority Data
Dec. 10, 2019 (FR) FR1914019

(51) Int. Cl. G06F 30/20; G06F 3/01; G06T 19/20; G06F 3/0346; G06T 17/00

(52) U.S. Cl. CPC G06F 30/20; G06F 3/014; G06T 19/20; G06F 3/0346; G06T 17/00; G06T 2219/2016; G06T 2210/56

(57) ABSTRACT

A device for defining a generic movement sequence on a generic model includes a means for acquiring the position of a reference element moving over a surface. The reference element is configured to perform an actual movement sequence. The device also includes a means for recording the sequence of actual movements, a means for acquiring a three-dimensional representation of the surface, a means for adapting the generic model to the three-dimensional representation of the surface, and a means for defining a generic movement sequence on the generic model by applying, to the real movement sequence, the adaptation between the generic model and the three-dimensional representation of the surface.

### TECHNICAL FIELD

The invention relates to the field of defining at least one movement sequence on a generic model, that is, on a digital model with preset parameters to represent a group of subjects.

The invention may be applicable in numerous technical fields in which the work surface is variable among several individuals within the subject group. Typically, the invention finds a particularly advantageous application for defining one or more massage trajectories on a generic human body. Alternatively, the individuals in the subject group may correspond to physical objects. For example, the group of subjects may correspond to porcelain plates, and the invention may find application in defining the trajectory of painting on these porcelain plates.

The use of this movement sequence of the reference element on the generic model is also variable. Indeed, by recording several movement sequences associated with different subjects and defining them on the generic model, it is possible to compare two actions performed on different subjects. Furthermore, this movement sequence defined using the generic model may also be used to control a robot comprising means for adapting the generic movement sequence to a particular subject.

### BACKGROUND

Unlike industrial robots programmed to follow a preset trajectory, a robot operating on an unknown surface must include a means to manage movement that can analyze the surface to determine a trajectory.

For example, reconnaissance robots generally integrate at least one camera, and image processing means analyzing, over time, the exploration surface and determining the trajectory to be followed for the robot.

This method of analyzing an unknown surface requires a great deal of computing power to precisely guide the robot's movements over time. Therefore, it follows that the exploration robots should move slowly to allow the movement management device to optimize the movements of the robot according to the information acquired by the camera and processed by the image processing means.

In addition, for a massage robot or an artisanal porcelain painting robot, the robot's movements must be extremely precise to massage the desired areas on an individual's body or apply the layers of paint to the desired places.

For this purpose, the known process of scanning a three-dimensional surface enables an operator to program the movements of a robot by using a three-dimensional digital modeling of the surface to be processed by the robot. For example, document WO 2015/187092 describes a massage robot incorporating a three-dimensional scanner to scan a patient's body and allow a practitioner to determine the massage trajectory of the robot using the projection of a model in three dimensions of a patient's body on a touchpad.

It is also possible to use a robot with a generic model for which at least one movement sequence is known. The robot can then adapt the generic model to the subject while distorting the movement sequence to apply a treatment to a particular subject.

It is also necessary for this type of robot to define at least one movement sequence on the generic model. As for the definition given in document WO 2015/187092, the definition of at least one movement sequence on the generic model is generally carried out manually by an operator tracing a plot on the generic model.

Thus, the definition of this movement sequence may be particularly long due to the precision sought.

The invention's technical problem consists of facilitating the process of defining at least one movement sequence on a generic model.

### SUMMARY OF THE DISCLOSURE

This invention aims to respond to this technical problem by acquiring the movements of a reference element evolving on a surface of variable geometry and by adapting the movements captured on the generic model.

In the sense of the invention, the “reference element” may correspond to an effector or a point or a set of reference points corresponding to a physical element. For example, the reference element may correspond to a glove or a set of points representing a practitioner's hand. Two methods may be used to adapt the real movements to the generic model.

A first method consists of transforming the generic model to adapt to the subject before acquiring the movement sequence. The acquisition of the movement sequence is then recorded directly on the transformed generic model. When the movement sequence is finished, the generic model is transformed again to take back these initial parameters, and the movement sequence is then transformed by taking back the same transformations as those applied to the generic model so that the real movement sequence is transformed into a generic movement sequence.

A second method is to acquire the movement sequence independently from the generic model and calculate the difference between the subject and the generic model to apply this difference to the movement sequence to transform the real movement sequence into a generic movement sequence. This second method nevertheless requires correctly repositioning the generic movement sequence on the generic model.

This second method is only possible for transformations of the translation, rotation, and scaling type, whereas the first method, may be applied to other types of transformations. In both cases, the invention relates to a device for defining a generic movement sequence on a generic model, said device comprising:
a means for acquiring the position of a reference element moving over a surface; said reference element is configured to perform an actual movement sequence;
a means for recording said sequence of actual movements;
a means for acquiring a three-dimensional representation of said surface;
a means for adapting said generic model to said three-dimensional representation of said surface; and
a means for defining a generic movement sequence on said generic model by applying, to said real movement sequence, said adaptation between said generic model and said three-dimensional representation of the said surface.

In the first case, said adaptation means are configured to adapt said generic model to said three-dimensional representation of said surface; said recording means are configured to record said sequence of real movements on said generic model while it is adapted to said dimensions of said three-dimensional representation of said surface; and said definition means are configured to transform said generic model with said movement sequence recorded, so that said generic model resumes these initial parameters.

In the second case, said adaptation means are configured to calculate the difference between said generic model and the three-dimensional representation of the surface; said recording means are configured to record the actual movement sequence independently of the generic model; said means of definition are configured to transform the movement sequence recorded according to the difference calculated by the adaptation means, and the device includes means for positioning said generic movement sequence on said generic model.

Whatever the adaptation method used, the invention makes it possible to practically define a movement sequence on a generic model with no need to visualize the three-dimensional representation of the surface or the generic model.

It is thus possible to capture several movement sequences and adapt them to the same generic model to compare several trajectories carried out on said same surface or several different surfaces.

In the example of the painting of artisanal porcelain, the invention thus makes it possible to know the movements most often carried out by painters. Moreover, by examining the different renderings, it is possible to determine which movements are the most effective.

In the same way, in the example of the follow-up of the massage trajectories, it is possible to know the points most often solicited by the practitioners or to record one or more massage trajectories so that a robot may reproduce them. These massage trajectories may also be recorded on different individuals. In addition, multiple movement sequences may be digitized to perform several different types of massage. Several generic models may also be created to improve the adaptation of the generic model with the patient's body, for example, by using three types of generic models for each gender: a large, petite, and average-sized person and for different age types: children, teenagers and adults; and/or for each recording position: sitting position, standing position and lying position.

According to one embodiment, said means for acquiring said reference element position is configured to pick up the orientation of the reference element to transfer this orientation to the different points of the generic movement sequence.

According to one embodiment, said means for acquiring said position of the reference element are configured to pick up the actions performed or the constraints undergone by said reference element to report these actions or these constraints on the different points of the generic movement sequence.

This embodiment makes it possible, for example, to control the operation of actuators during the robot's movements. In the example of the handcrafted porcelain painting robot, the robot can perform specific surface treatments in certain places. In the example of the massage robot, certain positions of the robot can control the means to trigger vibration to improve the comfort and/or the effect of the massage. Moreover, the generic movement sequence may thus comprise several trajectories carried out with a palpating-rolling movement while other movements are carried out with another type of movement. Thus, the stresses undergone by the reference element may correspond to physical stresses, for example, pressure or temperature, or external stresses, for example, sounds emitted during a massage or diffusion of essential oils.

According to one embodiment, said generic model and the three-dimensional representation of the surface being formatted into said shape of point clouds, said adaptation means comprise:
a means for calculating a normal direction to each point of said three-dimensional representation of said surface; and
a means for searching, for each point of the point cloud of said three-dimensional representation, the point of the generic model in close vicinity for which the difference between the normal direction of the point of the generic model and the normal direction of the point of interest is the lowest;
a means for determining a distance between said detected point of the generic model and said point of interest; and
a means for searching for a global transformation of the generic model as a function of the distances determined for all the point cloud points of said three-dimensional representation.

The normal directions make it possible to obtain information relating to the orientation of the generic model's surfaces and the three-dimensional representation of the surface. Unlike a simple point-to-point coordinate comparison, a surface comparison provides more efficient recognition.

In addition, the adaptation of the generic model or the movement sequence is carried out step by step by modifying the generic model or the movement sequence little by little according to the average of the distances.

It follows that this embodiment makes it possible to effectively adapt the generic model or the movement sequence by comparing the normal directions of each point of the generic model or the movement sequence and the normal directions of the three-dimensional representation of the surface.

According to one embodiment, said search means are configured to search for the points of the generic model in a preset sphere around the point of interest.

This embodiment is intended to limit the search area of the generic model points to limit the computation time. In addition, the limitation of the search zone also makes it possible to limit the amplitude of the generic model's modification between the two comparisons, thus increasing the precision of the generic model's modification.

According to one embodiment, the normal directions are determined by constructing a surface using the coordinates of the three or four points closest to the point of interest.

This embodiment makes it possible to efficiently construct the generic model's surfaces and the three-dimensional representation of the surface.

According to one embodiment, said adaptation means comprise:
a means for detecting feature points on said three-dimensional representation; and
a means for transforming the generic model in rotation and/or in translation, so that said position of said feature points corresponds to a position of feature points of the generic model.

This embodiment allows a first rough adaptation of the generic model to be created to improve the speed of the precise adaptation performed through the normals. In the example of the handcrafted porcelain painting robot, the feature points may correspond to the upper and lower ends of the porcelain.

In the example of the massage robot, the feature points may correspond to the upper end of the skull, the position of the armpits, and the position of the crotch.

According to one embodiment, said acquisition means comprises means for pre-processing said three-dimensional representation by means of capturing multiple three-dimensional representations and averaging the coordinates of points between the different three-dimensional representations. This embodiment makes it possible to improve the precision of the representation in three dimensions and, therefore, the adaptation of the generic model.

According to one embodiment, said pre-processing means performs filtering of said average of the coordinates of the points between the different representations in three dimensions. This embodiment also makes it possible to improve the precision of the representation in three dimensions and, therefore, the adaptation of the generic model.

According to one embodiment, said reference element corresponds to a glove, and said movement sequences correspond to movements made by said glove during a massage.

### BRIEF DESCRIPTION OF THE FIGURES

The way of carrying out the invention, as well as the advantages which result from it, will become apparent from the embodiment which follows, given by way of indication but not limitation, in support of FIGS. 1 to 3, which constitute:

FIG. 1: a flowchart of the steps to determine a transformation of a generic model according to one embodiment of the invention;

FIG. 2: a flowchart of the operating steps of a device to define a generic movement sequence on a generic model according to a first embodiment; and

FIG. 3: a flowchart of the operating steps of a device to define a generic movement sequence on a generic model according to a second embodiment.

In the following description, the invention is described with reference to a definition of a massage sequence. However, the invention is not limited to this specific application, and it may be used for various movement sequences linked to surfaces whose geometry is not preset.

### DETAILED DESCRIPTION

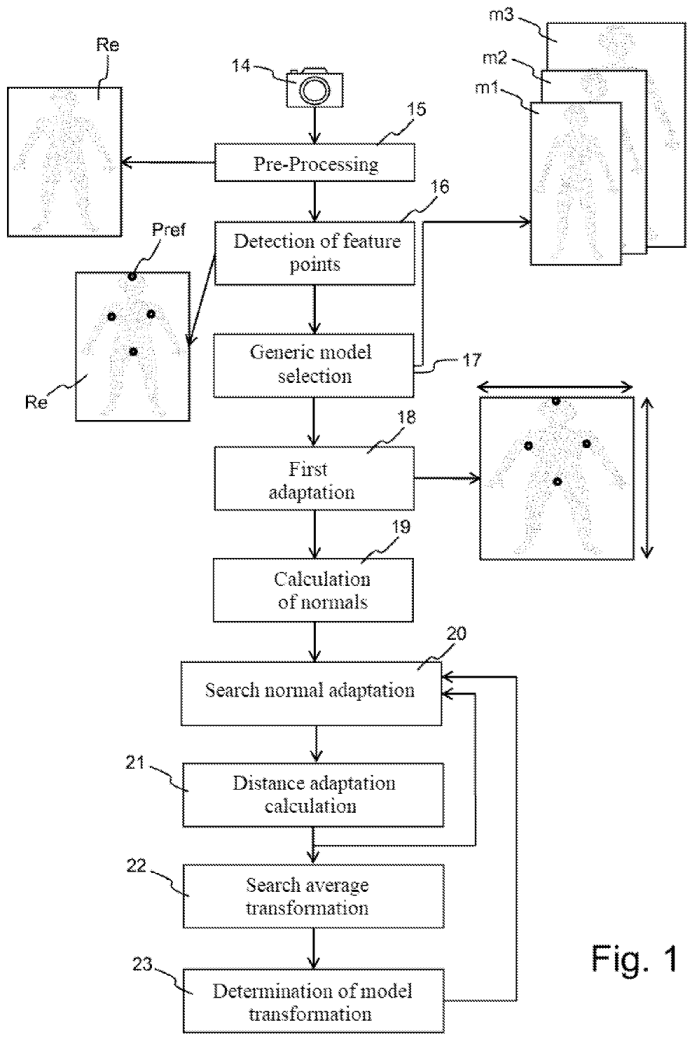

As illustrated in FIG. 1, the surface analysis is carried out by acquisition means 14 capable of providing a three-dimensional representation Re of the surface. The three-dimensional representation Re takes the form of a point cloud in which each point has three coordinates of an orthonormal system: x, y, and z.

This acquisition means 14 may correspond to a set of photographic sensors, a set of infrared sensors, a tomographic sensor, a stereoscopic sensor, or any other known sensor making it possible to acquire a three-dimensional representation of a surface. For example, the Kinect® camera from Microsoft® may be used to obtain this three-dimensional representation Re.

To obtain this three-dimensional representation Re without capturing the environment, it is possible to capture a first point cloud corresponding to the environment and a second point cloud corresponding to the surface in its environment. Only the different points between the two-point clouds are kept to extract the points corresponding to the surface from the environment. This method makes it possible to abstract from a standardized environment for recording and adapt to any environment.

As illustrated in FIG. 1, these sensors 14 are often implemented with pre-processing means 15 to provide a three-dimensional representation Re with improved quality or precision. For example, the pre-processing means 15 may correspond to an algorithm for equalizing histograms, filtering, averaging the representation over several successive representations, etc.

For example, it is possible to use the approach described in the scientific publication “KinectFusion: Real-time 3D Reconstruction and Interaction Using a Moving Depth Camera*” published on Oct. 16, 2011, in UIST′11 to obtain a representation in three dimensions of better quality. The device then implements computer processing to adapt a generic model m1, m2, m3 with the three-dimensional representation Re. The generic models m1, m2, m3 are also formatted in the shape of a point cloud in which each point has three coordinates of an orthonormal system: x, y, and z. Preferably, the generic model comprises an average model ModMoy of N vertices of three coordinates and a transformation matrix ModSigma of M morphological components by 3N coordinates, that is to say, three coordinates for N vertices. Many different people are needed to enrich each generic model m1, m2, m3, for example, a thousand people.

A principal component analysis is applied to reduce the dimension of the data. By applying a principal component analysis to these data, it is possible to determine the variance in the data and associate the common variance with a component. Thus, instead of keeping one component per person, each generic model m1, m2, m3 stores about twenty components, explaining the majority of the variance for the thousand people. This method is described in more detail in the scientific publication “Building Statistical Shape Spaces for 3D Human Modeling, Pishchulin et al.,” published on Mar. 19, 2015, in the journal “Published in Pattern Recognition 2017”.

Preferably, the generic models m1, m2, m3 are stored in a memory accessible by the image processing means of the device capable of adapting a generic model m1, m2, m3 with the three-dimensional representation Re.

To do this, when the three-dimensional representation Re is obtained, the device implements detection of the feature points Pref of this three-dimensional representation Re by digital processing means 16. In the example of FIG. 1, the feature points Pref correspond to the upper end of the skull, the position of the armpits, and the position of the crotch. This digital processing means 16 can implement all known methods for detecting elements in an image, such as the Viola and Jones method, for example.

Preferably, to detect the feature points Pref, the point cloud is transformed into a depth image, that is, an image in gray levels, for example coded on 12 bits, making it possible to code depths ranging from 0 to 4095 mm. This depth image is then thresholded and binarized to highlight only the pixels corresponding to the object/body of interest with a value of 1 and the pixels corresponding to the environment with a value of 0. Next, edge detection is applied to this binarized image using, for example, the method described in Suzuki, S., and Abe, K., Topological Structural Analysis of Digitized Binary Images by Border Following, CVGIP 30 1, pp 32-46 (1985). Finally, the contour's salient points and its convexity defects (determined using, for example, the method Sklansky, J., Finding the Convex Hull of a Simple Polygon. PRL 1 $number, pp 79-83 (1982)) are used as Preffeature points.

Means 17 for selecting the generic model m1, m2, m3 are then implemented to select the generic model m1, m2, m3 closest to the three-dimensional representation Re.

For example, this selection may be made by calculating the distance between the feature point Pref of the top of the skull and the feature point of the crotch to roughly estimate the size in the height of the three-dimensional representation Re and by selecting the generic model m1, m2, m3 for which the size in height is closest. Similarly, the selection of the generic model m1, m2, m3 may be carried out by using the width of the three-dimensional representation Re by calculating the distance between the feature points Pref of the armpits.

Furthermore, the generic model m1, m2, m3 may be articulated thanks to virtual bones representing the most important bones of the human skeleton. For example, fifteen virtual bones may be modeled on the generic model m1, m2, m3 to define the position and shape of the spine, femurs, tibias, ulnas, humeri, and skull. Furthermore, the orientation of these virtual bones makes it possible to define the pose of the generic model, i.e., if the generic model m1, m2, m3 has one arm in the air, the legs apart . . . .

The selection may also determine this pose of the generic model m1, m2, m3 means 17 by comparing the distance (calculated, for example, using the Hu method. Visual Pattern Recognition by Moment Invariants, IRE Transactions on Information Theory, 8:2, pp. 179-187, 1962.)) enters the depth image contour of the object/body of interest with a depth image contour database of generic models in several thousand postures. The depth image of the m1, m2, m3 articulated generic model closest to the depth image of the object/body of interest is selected, and the rotation values of the virtual bones are saved.

A first adaptation is then performed by adaptation means 18 by transforming the generic model selected to approach the three-dimensional representation Re. For example, this first adaptation may simply transform the width and height of the generic model selected so that the spacing of the feature points Pref of the generic model selected corresponds to the spacing of the feature points Pref of the three-dimensional representation Re. This first adaptation may also define the pose of the virtual bones of the generic model m1, m2, m3.

Following this first rather rough adaptation, it is possible to use a second, more precise adaptation by using the normal directions formed by each surface defined between the points of the three-dimensional representation Re. To do this, the device incorporates means for calculating the normals 19 of each surface of the three-dimensional representation Re and of the selected generic model.

For example, normal directions may be determined by constructing each surface of the three-dimensional representation Re using the coordinates of the three or four points closest to the point of interest. As a variant, the normal directions of the generic model may be calculated during the step to define the generic model.

The device then uses search means capable 20 of detecting, for each point of the point cloud of the three-dimensional representation Re, the point of the generic model selected nearby for which the difference between the normal direction of the point of the generic model and the normal direction of the point of interest is the smallest. When the virtual bones are a component of the generic model selected, the search means 20 adapt the position and the size of the virtual bones by varying the features of each virtual bone to adapt the virtual bones to the position of the elements of the body present in the three-dimensional representation Re.

For example, the search means 20 may be configured to search for the points of the generic model in a preset sphere around the point of interest. Preferably, the radius of this sphere is determined according to the number of vertices of the generic model and the size of the object/body of interest in such a way that about ten points are included in this sphere.

Using all of these normal directions, the device can then calculate the difference between the selected generic model and the three-dimensional representation Re using determination means 21 capable of calculating the distance between the points of interest and the points detected by the search means on the selected generic model. All of these distances form vectors of transformations that should be applied to the point of interest to correspond to the detected point. Search means 22 designed to determine an average of these transformation vectors to obtain an overall transformation of the generic model selected.

In other words, by considering a new transformation vector CompVec of M components, it is possible to know the three-dimensional configuration of the Pts3D vertices by applying the following equation:

Pts3D=ModAv+CompVec*ModSigma

For an unknown Pts3D configuration, for example, in the case of a new patient, the goal is to seek the values of the morphological components CompVec which correspond to this person knowing the average model ModAverage and the transformation matrixModSigma.

To do this, the search means 22 calculates the difference DiffMod between the three-dimensional configuration of the vertices Pts3D and the average model ModMoyen and the pseudo-inverse matrix ModSigmaInv of ModSigma.

For example, the pseudo inverse matrix ModSigmaInv may be calculated by decomposing the ModSigma matrix into singular values using the following equations:

ModSigma=VU*;

ModSigmaInv=VEt U*;

with Et corresponding to the transposed matrix of E;

V* being the trans conjugated matrix of V; and

U* being the trans conjugated matrix of U.

Using these data, the search means 22 calculates the morphological components CompVec using the following equation:

DiffMod*ModSigmaInv=CompVec*ModSigma*ModSigmaInv

That is, CompVec=DiffMod*ModSigmaInv, which also makes it possible to obtain the CompVec morphological components for a specific patient.

The CompVec transformation vector is then applied to the selected generic model. The pose is again estimated as before, the generic model is adjusted if necessary, and a new search is performed until the generic model is close enough to the three-step representation dimensions Re. Finally, the loop stops when the average Euclidean distance between all the vertices of the generic model and those corresponding to them on the point cloud is lower than a threshold defined according to the number of the generic model's vertices and the size of the object/body of interest, 2 mm for example, or when a maximum number of iterations, 100 iterations, for example, is reached while the average distance below the threshold has not yet been reached.

A calibration phase between sensor 14 and the robot must often be carried out. To calibrate vision sensor 14 and the robot, it is possible for the coordinates of at least three common points in the two markers to be recorded. In practice, using a number of points N greater than three is preferable. The robot is moved over the work area and stops N times.

At each stop, the robot's position is recorded by calculating the movements carried out by the robot's movement command, and detection makes it possible to know the position of this stop in three dimensions by means of the vision sensor 14.

At the end of these N stops, the coordinates of the N points are known in the two reference frames. The barycenter of the distribution of the N points in the two frames is determined using the following equations:

BarycentreA=1/N sum(PA(i)) for i=1 to N with PA(i) a point in the sensor's frame of reference 14; and

BarycentreB=1/N sum(PB(i)) for i=1 to N with PB(i) a point in the robot's frame.

The covariance matrix C is then determined by the following equation:

C=sum((PA(i)−BarycentreA)(PB(i)−barycentreB)t) for i=1 to N

This covariance matrix C is then decomposed into singular values:

C=UEV*

The following equation then obtains the rotation matrix R between the two reference marks:

R=VUt; if the determinant of R is negative, it is possible to multiply the third column of the rotation matrix R by −1.

The following equation determines the translation to be applied between the two markers:

T=−R*BarycentreA+BarycentreB

It is thus possible to convert any point of the reference frame of the sensor 14 Pa into the reference frame of the robot Pb by applying the following equation:

Pb=R*Pa+T

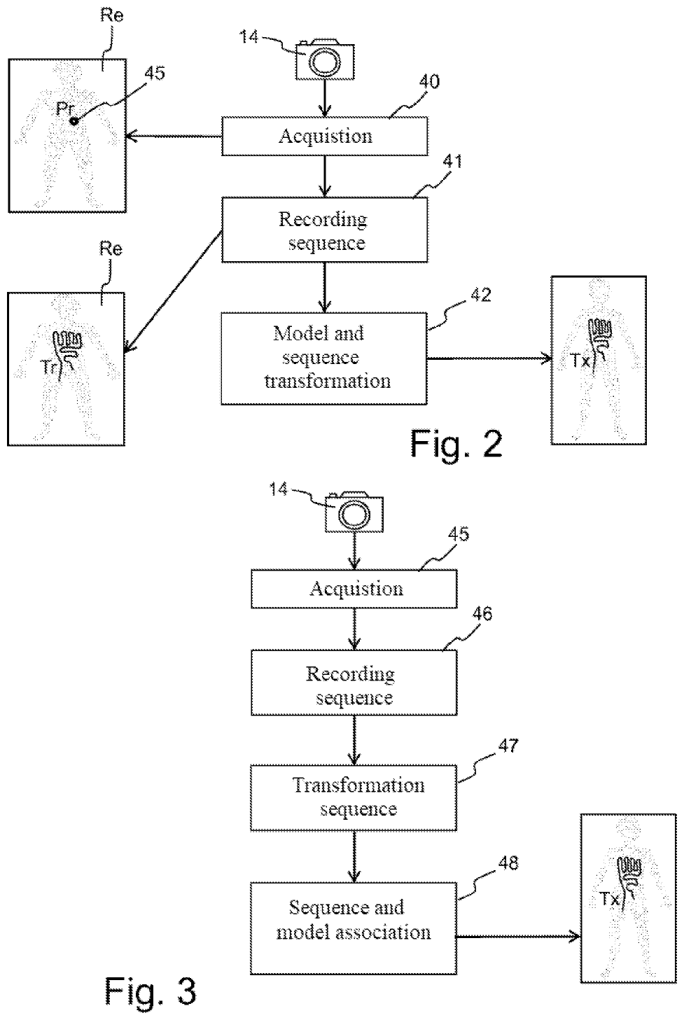

In the first embodiment of the invention, illustrated in FIG. 2, the adaptation of the selected generic model makes it possible to acquire a position Pr of a reference element 45 directly on the adapted generic model.

The acquisition is carried out, in one step 40, by determining the position Pr of the reference element 45 on the three-dimensional representation Re of the surface. The reference element may correspond to an effector or a reference point or set of reference points corresponding to a physical element. For example, the reference element may correspond to a glove or a set of points representing a practitioner's hand. The position Pr of the reference element 45 on the three-dimensional representation Re of the surface may be determined by a position triangulation module or by an image processing analysis analogous to that used to capture the representation in three dimensions Re of the surface. In addition to the position Pr of the reference element 45 on the three-dimensional representation Re of the surface, the acquisition may also make it possible to capture an orientation of the reference element 45 or actions carried out with the reference element 45, such as heating, or a particular movement.

The acquisition is reproduced several times in step 41 to form a sequence of recordings Tr illustrating the actual movements performed by the reference element 45. For example, the acquisition may be performed every 0.1 s.

When the movement sequence Tr is finished, the points of the sequence Tr are projected onto the generic model transformed into the person's morphology. Then, the generic model is again transformed to resume these initial parameters.

To do this, the transformations of the generic model are calculated from the initial parameters to the parameters of the transformed generic model. Then, the movement sequence Tr is transformed using the same transformations as those applied to the generic model.

Thus, Tr's real movement sequence is transformed into a generic movement sequence Tx associated with a generic model.

In a second embodiment of the invention, illustrated in FIG. 3, the acquisition 45 is performed independently of the generic model. In this embodiment, step 23 of FIG. 1 merely determines the transformations of the generic model without actually applying them. To match the movement sequence Tx to the generic model, the movement sequence may pass through the feature points of the surface morphology. For example, acquisition 45 may be performed by moving the reference element 45 at the top of the skull and the armpit of the subject.

When the movement sequence Tr is recorded, in step 46, step 47 applies the difference between the generic model and the three-dimensional representation Re of the surface to transform the real movement sequence Tr into a generic movement sequence Tx. In a final step, 48 repositions the generic movement sequence on the selected generic model. Preferably, this step 48 is performed by seeking to match the feature points through which the reference element 45 has passed and the position of these feature points on the generic model. This step 48 may also be carried out by taking into account the position of the subject.

The invention thus makes it possible to define a generic movement sequence Tx on a generic model in a practical way, that is to say, without the operator needing to use a screen of a computer or a digital tablet. Thus, the invention makes it possible to greatly simplify the process of defining the movement sequence because the operator is often more efficient during a practical recording in a real situation.

This movement sequence may then be used for various applications, such as comparing several movement sequences or the control of a robot comprising means for adapting the generic movement sequence to a particular subject.

1. A device for defining a generic movement sequence on a generic model, wherein said device comprises:
a means for acquiring a position of a reference element moving over a surface; said reference element being configured to perform an actual movement sequence;
a means for recording said sequence of actual movements;
a means for acquiring a three-dimensional representation of said surface;
a means for adapting said generic model to said three-dimensional representation of said surface; and
a means for defining a generic movement sequence on said generic model by applying to said real movement sequence said adaptation between said generic model and said three-dimensional representation of said surface.

2. The device according to claim 1, wherein said adaptation means is configured to fit said generic model to said three-dimensional representation of said surface; said recording means is configured to record said actual movement sequence on said generic model as it is fitted to the dimensions of said three-dimensional representation of said surface and said defining means are configured to transform said generic model with said recorded movement sequence so that said generic model resumes those initial parameters.

3. The device according to claim 1, wherein said adaptation means is configured to calculate the difference between said generic model and said three-dimensional representation of said surface; said recording means is configured to record said actual movement sequence independently of said generic model said defining means are configured to transform said recorded movement sequence according to the difference calculated by said adaptation means; and wherein the device comprises a means for positioning said generic movement sequence on said generic model.

4. The device according to claim 2, wherein said acquisition means of said position of said reference element are configured to detect an orientation of said reference element to report this orientation on the various points of the sequence of the generic displacements.

5. The device according to claim 2, wherein said acquisition means of said position of said reference element are configured to detect the actions carried out or the stresses undergone by the said element of reference to transfer these actions or these constraints to the various points of the generic movement sequence.

6. The device according to claim 1, wherein said generic model and said three-dimensional representation of said surface being formatted in the shape of point clouds, said adaptation means comprise:
a means for calculating a normal direction to each point of said three-dimensional representation of said surface; and
search means for each point of the point cloud of said three-dimensional representation of the point of the generic model in a close neighborhood for which the difference between the normal direction of the point of the generic model and the normal direction of the point of interest is the lowest;
a means for determining a distance between said detected point of the generic model and said point of interest; and
means for searching for a global transformation of the generic model as a function of the distances determined for all the points of the point cloud of said three-dimensional representation.

7. The device according to claim 6, wherein said search means are configured to search for the points of the generic model in a preset sphere around the point of interest.

8. The device according to claim 6, wherein the normal directions are determined by constructing a face using the coordinates of the three or four points closest to the point of interest.

9. The device according to claim 1, wherein said adaptation means comprise:
a means for detecting feature points on said three-dimensional representation; and
a means for transforming the generic model in rotation and/or in translation, so that said position of said feature points corresponds to a position of feature points of the generic model.

10. The device according to claim 1, wherein said reference element corresponds to a glove and said movement sequences correspond to movements performed by said glove during a massage.
